(19) United States
(12) Patent Application Publication
(10) Pub. No.: US 2013/0030915 A1
(43) Pub. Date: Jan. 31, 2013

(54) APPARATUS AND METHOD FOR ENHANCED IN-STORE SHOPPING SERVICES USING MOBILE DEVICE

(71) Applicants: Stephen B. Statler, San Diego, CA (US); Ravi Halker, San Diego, CA (US); Eric R. Kraar, Atlanta, GA (US); Jonathan K. Kies, Encinitas, CA (US); Daniel J. Guest, (US); Frank T. Young, Palo Alto, CA (US); Kenneth Waldron, La Jolla, CA (US); Michele O. Gantt, Atlanta, GA (US); Ravikumar Devarajan, San Diego, CA (US); Ketal V. Gandhi, San Diego, CA (US); Atif J. Piracha, San Diego, CA (US)

(72) Inventors: Stephen B. Statler, San Diego, CA (US); Ravi Halker, San Diego, CA (US); Eric R. Kraar, Atlanta, GA (US); Jonathan K. Kies, Encinitas, CA (US); Daniel J. Guest, (US); Frank T. Young, Palo Alto, CA (US); Kenneth Waldron, La Jolla, CA (US); Michele O. Gantt, Atlanta, GA (US); Ravikumar Devarajan, San Diego, CA (US); Ketal V. Gandhi, San Diego, CA (US); Atif J. Piracha, San Diego, CA (US)

(73) Assignee: QUALCOMM INCORPORATED, San Diego, CA (US)

(21) Appl. No.: 13/363,580

(22) Filed: Feb. 1, 2012

Related U.S. Application Data
(60) Provisional application No. 61/582,884, filed on Jan. 4, 2012.
(60) Provisional application No. 61/500,604, filed on Jun. 23, 2011.

(51) Int. Cl. G06Q 30/00; G06Q 30/02

(52) U.S. Cl. 705/14.54; 705/14.71; 705/7.29; 705/14.58; 705/26.41

(57) ABSTRACT

Apparatus and methods are provided for offering shopping assistance tools. The tools may be used by developers to create enhanced in-store customer shopping applications. The shopping assistance tools provide in-store navigation, customer assistance, and inventory management services.

### CLAIM OF PRIORITY UNDER 35 U.S.C. §119

This application claims priority to provisional patent application No. 61/582,884, entitled “Apparatus and Method for Enhanced In-store Shopping Services Using Mobile Device,” filed Jan. 4, 2012, and to provisional patent application No. 61/500,604, entitled “Apparatus and Method for Enhanced In-store Shopping Services Using Mobile Device,” filed Jun. 23, 2011, both of which are assigned to the assignee hereof and hereby expressly incorporated by reference herein.

### BACKGROUND

1. Field

This application relates generally to shopping services using a mobile device, and more particularly to using a mobile device and applications to enhance in-store and online shopping.

2. Background

Online shopping is common and well-developed today. A mature ecosystem exists that is monetized via impressions and “click to actions,” and analytical tools are available to understand consumer behavior. There are rich sets of product information, ratings, comparisons, and reviews that help consumers to research products before they buy.

As the use of mobile devices for everyday tasks, including shopping, increases, more and more developers are deploying high quality shopping applications to support shopping via the Internet. In-store shopping, however, has not seen such development. Currently, retailers struggle with staffing to provide the quality of advice and information that can be gained online. Consumers are frustrated with attention when they do not want it and difficulties in getting adequate help when needed. In-store staff rarely knows enough about customers to provide the personalized service that is possible with online shopping recommendations. Manufacturers, who pay stores for placement of their products, have no efficient way of knowing the effectiveness of their product placements or how different consumers react to their products. Further, there is no simple system for rewarding mobile shopping application developers for driving foot traffic and in-store sales.

Thus, improvements to the in-store shopping experience for consumers, retailers, manufacturers, and developers are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to some aspects, a method for providing shopping assistance, comprises receiving a request for product information; obtaining a profile associated with the requestor and the product information; obtaining recommendations for one or more additional products based on previous behaviors of the requestor and the requested product; determining availability of the requested product; and providing the availability information and the recommendations for the one or more additional products to the requestor.

According to some aspects, a method for providing in-store navigation, comprises receiving a request for one or more products; retrieving a customer profile and an identifier associated with each of the one or more products; and generating in-store navigation directions indicating directions to each of the one or more products.

According to some aspects, a method for alerting a manufacturer to product demands, comprises receiving a search request for a product; determining if the product is available in a particular store; and alerting the manufacturer if the product is not available.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 depicts an exemplary shopping assistance system, in accordance with some aspects;

FIG. 2 is a flowchart depicts an exemplary process for providing shopping assistance, in accordance with some aspects.

FIG. 3 is a high level block diagram depicting a shopping assistance system, in accordance with some aspects;

FIG. 4 is a high-level layered view of the integration of information and functionality that defines shopping assistance system; in accordance with some aspects;

FIG. 5 depicts an exemplary mobile device, in accordance with some aspects;

FIG. 6 depicts an exemplary shopping assistant server, in accordance with some aspects;

FIG. 7 is a flowchart illustrating an exemplary business process, in accordance with some aspects;

FIG. 8 depicts an exemplary method of providing shopping assistance, in accordance with some aspects;

FIG. 9 depicts another method of providing shopping assistance, in accordance with some aspects;

FIG. 10 depicts an exemplary location server in accordance with some aspects;

FIG. 11 depicts an exemplary customer evaluator, in accordance with some aspects;

FIG. 12 depicts an exemplary inventory manager, in accordance with some aspects; and

FIG. 13 depicts an exemplary offer server, in accordance with some aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As will be described in detail herein, a shopping assistance system provides an integrated platform. Customers, retailers, manufacturers, and their services provider partners have the ability to exchange information and analytics relating to providing a better customer service experience.

In accordance with some aspects, the shopping assistance system allows customers to receive help when needed, and to avoid being disturbed when help is not desired. The shopping assistance system may maintain a customer profile. When a help related message is received at the shopping assistance system, if the help related message is a request for help, help can be dispatched based on the customer profile. If the message indicates that help is not wanted, assistants can be instructed not to approach the particular customer.

The shopping assistance system may also use positional information provided by a mobile device in addition to in-store location data, such as data provided by planograms combined with space maps or store maps, to provide location services to the mobile device. In tracking customer interaction with the system, the shopping assistance system is able to gather data, for example, from customer searches for products and information, to alert manufacturers to demand and issue opportunities. This interaction information also assists manufacturers and retailers in product placement decisions, as well as in determining offers and recommendations to provide to a customer.

The shopping assistance system additionally allows the tracking of the contribution of applications developers in steering customers to products, as well as the contributions of other system participants. As such, the system is able to compensate participants based on their contributions to steering customers to products.

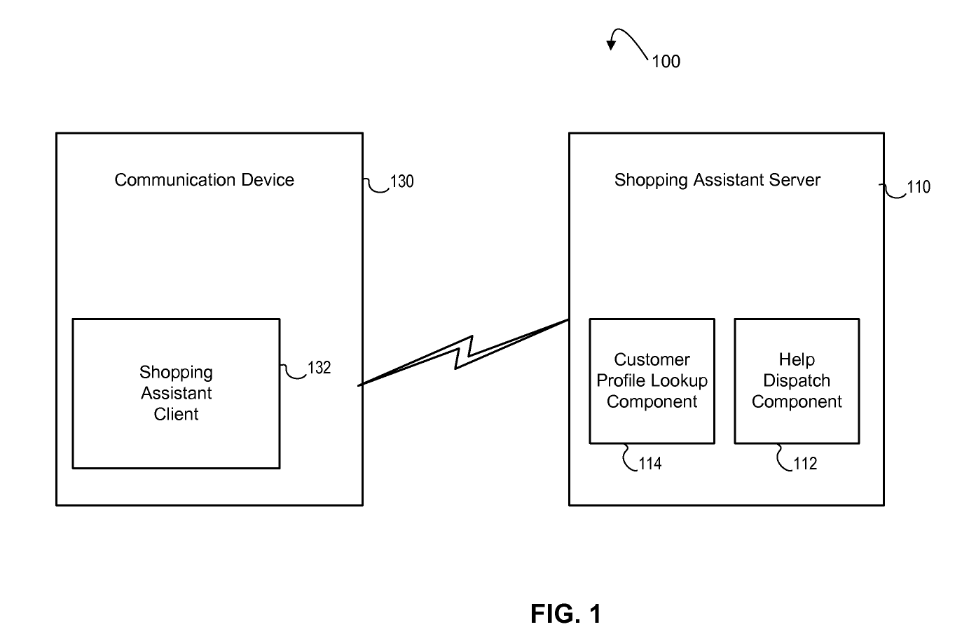

Turning now to FIG. 1, an exemplary system 100 for providing customer assistance is shown. A communication device 130 may be communicatively coupled to a shopping assistant server 110. Communication device 130 may include, for example, a portable wireless communication device such as, a smartphone, a tablet computer, a personal digital assistant, and/or any other portable wireless device. Other examples of communication device 130 may include any other device that enables the customer to interact with the shopping assistant server 110 while in a store such as a kiosk provided in the store, an electronic shelf display, a point-of-sale station, etc. Moreover, customers may use a device that enables the customer to interact with shopping assistant server 110 via a website over a wired or wireless internet connection, such as a laptop computer, a desktop computer, etc.

Communication device 130 may include one or more shopping assistant clients 132. Thus, each shopping assistant client 132 may access one or more combinations of information and functionality available via shopping assistant server 110. For example, a customer may wish to obtain additional information about a product of interest while in a store. Accordingly, shopping assistant client may be configured to launch a help messaging component that transmits a help request message to the application server. In some aspects, the help request message may identify the product that the customer needs help with. In other aspects, the help request message may be a general request for help that does not identify any particular product. At times, customers may also wish to browse without being interrupted by an assistant offering help. Accordingly, shopping assistant client may also be configured to transmit a do not disturb message, alerting the shopping assistant server that the customer does not wish to receive any help.

Shopping assistant server 110 may include a help dispatch component 112 and a customer profile lookup component 114. Help dispatch component 112 may be configured to receive and process help-related messages received from connected communication devices, such as communication device 130. Processing may include, for example, determining the type of help-related message has been received. For example, help dispatch component 112 may determine that the help-related message is a request for help in some aspects, or a request not to be disturbed in other aspects. In conjunction with customer profile lookup component 114, help dispatch component 112 may also be configured to dispatch an assistant to respond to a received help request based on a customer profile.

In some aspects, customer profiles may be stored at the shopping assistant server 110. In other aspects, the customer profiles may be stored remotely. Customer profile lookup component 114 may be configured to retrieve a customer profile associated with a customer identified in a help request message. Customers often establish profiles with specific retailers, manufacturers, or other service providers. A customer profile may include information such as, for example, information regarding customer preferences, a customer's priority level, purchase history, income level, the customer's known needs/interests, activities, payment accounts, loyalty accounts, credit score, etc. Using a retrieved customer profile, help dispatch component 112 can determine the type of help to dispatch in response to a help request. For example, the order in which help is dispatched to customers may be based on any one or more factors in the customer's profile. The customer profile may also be used to determine the type of expertise desired for an assistant being dispatched to help the customer. For example, if the customer has issued a general request for help, the type of assistant needed may be based on the customer's purchase history, search history, location, etc.

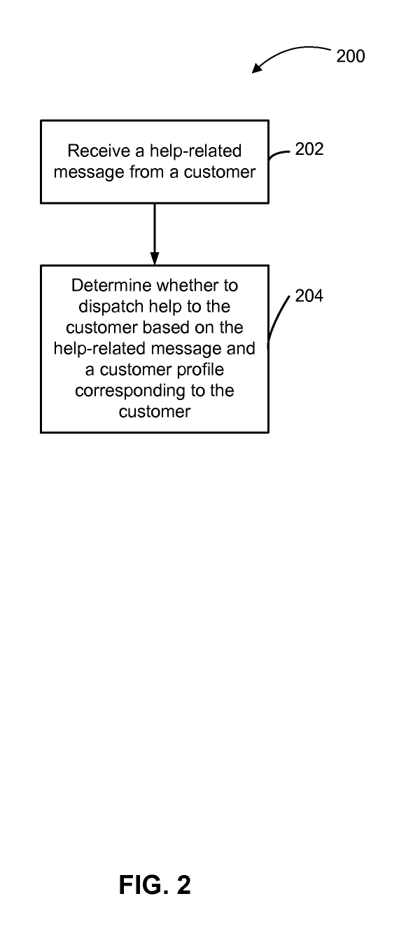

FIG. 2 is a flowchart illustrating a method for providing customer assistance, in accordance with some aspects. The method may be performed, for example, by shopping assistant server 110. As shown at 202, a help-related message may be received from a customer. The help-related message may be a message requesting help with a particular product, a general request for help, or instructions not to disturb the customer (e.g., a request not to provide help). As depicted at 204, a determination may be made as to whether to dispatch help to the customer based on the help-related message and a customer profile corresponding to the customer. For example, the help-related message may be a request for help, and the server may then determine to send an assistant to the customer. Based on the customer's profile, the server may determine, for example, which particular assistant to dispatch to the customer, when the assistant should be dispatched, etc.

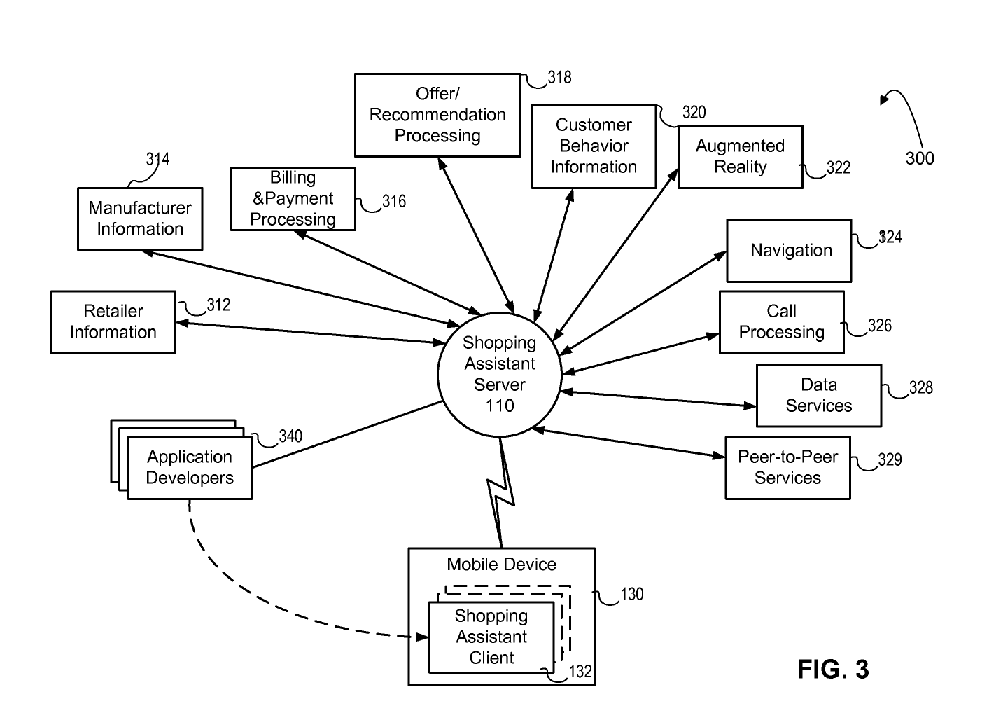

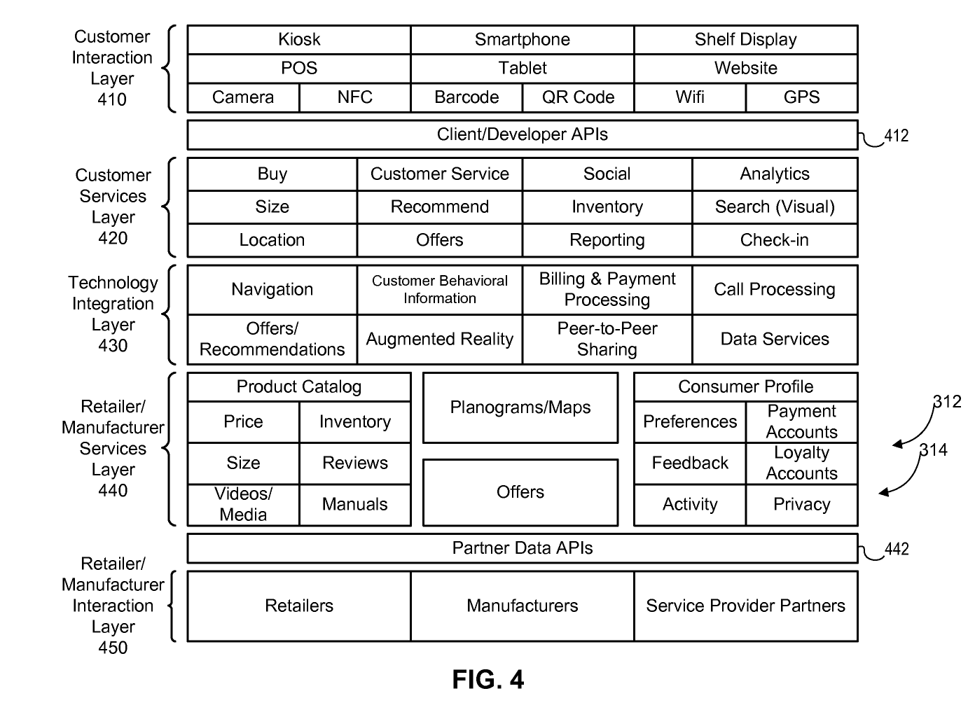

In addition to dispatching help to a customer upon request, shopping assistant server 110 may be configured to provide additional shopping assistance. With reference to FIGS. 3 and 4, a system for providing an enhanced shopping experience will now be described. FIG. 3 is a conceptual block diagram depicting a high-level integration of consumers, retailers, manufacturers, retail service-related providers, and developers, and corresponding information and functionality associated with each of these entities, in an integrated shopping assistance system 300. FIG. 4 is a high-level layered view of the integration of information and functionality that defines shopping assistance system 300. As depicted in FIG. 3, in one aspect of a shopping assistance system 300, shopping assistant server 110 is communicatively coupled to one or more communication devices 130 and one or more application developers 340. As described above, communication device 130 may include, for example, a portable wireless communication device such as, a smartphone, a tablet computer, a personal digital assistant, and/or any other portable wireless device. In addition, a customer may use any other device that enables the customer to interact with the shopping assistant server 110 while in a store such as a kiosk provided in the store, an electronic shelf display, a point-of-sale station, etc. Moreover, customers may use a device that enables the customer to interact with shopping assistant server 110 via a website over a wired or wireless internet connection, such as a laptop computer, a desktop computer, etc.

Communication device 130 may include one or more shopping assistant clients 132. Each shopping assistant client 132 may be written by one or more application developers 340, who, for example, develop mobile applications to enhance customer in-store and online shopping experience by integrating any combination of the information and functionality of shopping assistance system 300. For instance, application developers 340 may develop vertical applications that are associated directly with a particular retailer and that leverage the shopping assistant server 110, as well as horizontal applications that provide access to shopping across a plurality of retail sources. Application developers 340 may also develop, for example, applications associated directly with a manufacturer. In addition, application developers 340 may develop applications associated with any other entity that may result in directing traffic to a retailer. Thus, each shopping assistant client 132 may access one or more combinations of the information and functionality available via shopping assistant server 110.

In addition to dispatching help, shopping assistant server 110 may be configured to perform various other shopping related tasks. For example, customers often research products of interest both before going to a store and while in the store. Shopping assistant server 110 provides an integrated set of tools that enables retailers, manufacturers, and developers to share information and provide a more optimized shopping solution to customers, and these tools may be used as building blocks by application developer 340 to create shopping assistant client 132. For example, as depicted in FIG. 3, shopping assistant server 110 may provide an interface to retailer information 312 and manufacturer information 314. In addition, shopping assistant server 110 may provide an interface to various technology services such as billing and payment processing 316, offer/recommendation processing 318, customer behavior information 320, augmented reality services 322, navigation services 324, call processing 326, data services 328, peer-to-peer services 329, and/or various other technology services. These technology services may be provided via a technology integration layer 430 (FIG. 4). As such, application developer 340 is able to interact with shopping assistant server 110, such as via a software development toolkit, to develop one or more applications, e.g. shopping assistant client 132, that are able to interact with shopping assistant server 110, for example, to access the various information or functionality integrated through shopping assistant server 110.

In an aspect, retailer information 312 and manufacturer information 314 may be provided to, or accessible through, shopping assistant server 110 by retailers, manufacturers, and/or service providers via retailer/manufacturer/service provider interaction layer 450. As utilized herein, each of the “layers” of FIG. 4 represent at least a logical communicative coupling that defines a communication interface. In any case, retailer information 312 and manufacturer information 314 may include, for example, information provided to the shopping assistant server 110 and/or accessible by retailers, manufacturers, and service providers (entities that can assist retailers/manufacturers or provide technology integration functionality) via retailer/manufacturer/services layer 440. For example, retailers or manufacturers may provide product catalog including information such as product price, size availability, inventory, reviews, operational videos and other media, and operational manuals, etc. Retailers or manufacturers may also provide planograms along with space plans, to show how or where an item should be displayed or located in a store or on a shelf, or maps outlining the placement of products in a store. In some aspects, planograms/space plans/maps may be provided to represent all stores belonging to a retail chain, thus ensuring that the product placement is consistent among stores. In other aspects, different planograms/maps may be provided for each individual store. Retailers and/or manufacturers may also provide offers that may be provided to customers as well as rules indicating how the offers should be presented.

As described above, customers often establish profiles with specific retailers, manufacturers, or other service providers. Customer profile information associated with one or more retailers, manufacturers, or service providers may also be provided to shopping assistant server 110 via retailer/manufacturer services layer 440. Profile information may include, for example, information regarding customer preferences, activities, payment accounts, loyalty accounts, credit score, etc. In addition, the retailer/manufacturer/service provider may provide information regarding any privacy provisions associated with the profile information of the customer.

Manufacturers, retailers, and/or service provider partners may access the various services provided by retailer/manufacturer services layer 440 via one or more partner data APIs. To aid in developing shopping applications, application developers 340, as well as retailers, manufacturers, and service providers all have access to information provided via retailer/manufacturer services layer 440, and have access to the tools provided by technology integration layer 430. These tools may include, for example, navigation tools, customer behavior tools, billing and payment processing tools, call processing tools, offers/recommendations tools, augmented reality tools, peer-to-peer sharing tools, data services, and/or other tools.

Navigation tools may provide location information of a customer or a mobile device being used or carried by the customer. In an aspect, such location information may be combined with the planograms/space plans/maps to track the customer's movements throughout a store. In particular, for example, in-store navigation methods may be provided that leverage global positioning system (GPS) or other satellite and/or terrestrial location information provided by a customer's mobile device working in conjunctions with in-store location points, which may be obtained, for example, from planograms combined with space maps or store maps, to pinpoint a customer's location. The navigation tools may also be used to provide information to the customer about the location of products of interest.

Information about customer behaviors may be obtained from one or more external sources, or via monitoring. Behavior information may include, for example, past shopping patterns, size information, brand affinity, shopping frequency, etc., of the customer.

Payment processing tools may provide a mechanism for a customer to pay for products using their mobile device, while billing processing provides a mechanism for billing manufacturers/retailers and providing payments to application developers who drive foot traffic to the manufacturer/retailer. Call processing tools may be used to assist in making any phone calls needed to aid a customer's in-store shopping experience.

As described above, retailers/manufacturers may wish to provide offers/recommendations to customers based on various factors. Offer/recommendations may be targeted based on buying patterns, behaviors in-store, and/or other profile information of a customer. For example, if a customer has repeatedly requested information about products in a particular product category, but has not purchased such a product, the system may provide an incentive to the customer to purchase a product from that category via recommend/offer services based on relevance of that product to the customer based selection.

Technology integration layer 430 may provide augmented reality (AR) services, enabling retailers/manufacturers/service providers to provide enhanced product information to customers. For example, AR services may include a live direct or an indirect view of a physical, real-world environment whose elements are augmented by computer-generated sensory input, such as sound or graphics. The elements rendered by the AR services may be submitted by manufactures and stored in the media component of retailer/manufacturer services layer 440 for use in applications created by developers. In an aspect, selected AR services may be integrated into shopping assistant client 132 to provide, for example, additional information about a product, retailer or manufacturer, or to provide incentives, offers, or recommendations, etc. Using AR to render large amounts of product information around the object that the information relates to the customer can navigate that information through slight changes in the orientation of their handset without the need to touch the screen on the handset as they would otherwise be required to do in order to navigate through a screen hierarchy or page through the information. Technology integration layer 430 may also provide one or more peer-to-peer sharing tools, which may, for example, enable a customer to scan or communication with a peer device near a product of interest to obtain additional information about the product directly from the peer device. Data services, such as, for example, security, monitoring, data collection, and analysis tools may also be provided via technology integration layer 430.

Customers may access service provided by technology integration layer 430 via customer interaction layer 410 and customer services layer 420. As described above, customers may access shopping assistant server 110, or execute shopping assistant client 132, using various devices, such as smartphones, tablets, kiosks, point-of-service stations, shelf displays, displays mounted on shopping carts, websites, etc. Technology integration layer 430 may leverage technology provided by the user device, such as, for example, cameras, near field communication (NFC), barcode readers, quick response (QR) code readers, WiFi, GPS, etc. Customers may access the various services provided by customer services layer 420 through shopping assistant client 132, which in an aspect interfaces with customer services layer 420 via one or more client/developer application programming interfaces (APIs).

In an aspect, customer services layer 420 may provide services related to buying. A buying service may include, for example, options to pay for products via the mobile device, price matching tools, online ordering for products not available in the store, inventory management, electronic receipts, return date tracking, gift purchasing, price referral monetization, haggling, group purchases, sales watches/alerts, bartering, reverse auctioning, price drop alerts, automated upsells, discount information, etc. Placing these capabilities in the hands of customers while they are in-store encourages customers to complete their purchase in-store, mitigating the Research In Store Buy On-line (RIBO) phenomenon. The customer services layer 420 may also provide services related to product sizing, such as, determining if a requested size is available, whether other locations have the correct size, size/brand comparisons, size comparisons based on previous purchases, fit information. The sizing information may leverage the AR capabilities described above to enable a user to combine images of a product with non-virtual images, such as an image of a room or an image of a person, for example, to see how the product would look in the user's home (e.g., for furniture), or on the person (e.g., for clothes).

Location information may also be provided via customer services layer 420. For example, the particular locations in the store that a customer has stopped may be tracked as well as the amount of time spent in particular departments or aisles. Location information may be color coded by customer priority. For example, high value customers may be highlighted with particular color code. In some aspects, the look, e.g. color, style, format, behavior, etc., of the application being used by the customer may change based on the customer's location, the brand of store, etc. Further, location information may be used to track foot traffic through the store to highlight high traffic and/or low traffic volume areas and to track the velocity of movement of customers through different areas, for example, for use in analytics by retailers or manufacturers to improve product placement or store layout to increase sales. In some aspects, a customer's location can be determined based on the known location of one or more products. For example, a customer may request information about a product, for example, by scanning a QR code or barcode associated with the product. The customer's location may then be determined based on store specific surveys description the geography of the store (e.g., latitude and longitude coordinates associated with the location of the store) and retailer planograms outlining product layout information. The determined location may then be used to located the customer in order to dispatch help to the customer.

In some aspects, customers may check-in to the store either by scanning a QR code placed near the entrance or opting in when passing through a geo-fence or perimeter around the store established using GPS coordinates, loyalty account information that may have been previously entered into the system by customers may be used to present relevant offers to the customer as they navigate the store. The check-in process when a customer scans a QR code at a known location by the store entrance may assist in location determination.

Customer service, recommendations/offers, inventory management, social network integration, searching, reporting, and analytics may also be provided via customer services layer 420. Customer service may include, for example, maintaining customer preferred brand information, providing help when desired by a customer, alerting retail associates that a customer does not wish to be disturbed, bringing items to a customer upon request via the application, linking reward emails, providing deals/rewards as the customer moves through the store, loyalty check-in points, retail staff evaluations, personal shopper applications, customer service call centers.

Offers may be targeted to specific customers based on factors set forth by a retailer or manufacturer. With respect to recommendations, customer services layer 420 may provide information regarding products that match or coordinate with already selected products, recommendations of items that match currently owned products. In some aspects, recommendations may be provided only when the item is in stock in the size, color, style, etc. desired by the customer.

Customer services layer 420 may provide a link to social networking, for example, by providing tools to enable a customer to determine whether any of their social network friends have a product the customer is considering, find items that their friends have previously purchased, request coupons from friends, coupon sharing and exchange, read reviews of other purchasers, visit fashion blogs, view fashion videos, recommend products to friends, determine if any friends are nearby, etc. In some aspects, customer services layer 420 may provide product reviews and/or ratings, for example, when a customer scans a QR code associated with a particular product, or executes a search for a product.

With respect to inventory, customer services layer 420 may alert retailers/manufactures in advance that product availability is low, or that products being searched are not available. Scheduled reports may be provided to retailers/manufacturers.

Thus, shopping assistance system 300 provides an integrated platform, e.g. shopping assistant server 110, that allows each application developer 340 to develop one or more shopping assistant clients 132 that utilize any combination of the information and functionality available via shopping assistant server 110. Further, shopping assistance system 300 provides retailers, manufacturers, and their service provider partners with the ability to exchange information and analytics relating to customers in order to improve sales and meet customer desires. Additionally, as will be discussed in more detail below, shopping assistance system 300 allows the tracking of contribution of applications developers in steering customers to products, as well as the various contributions of the other system participants. Accordingly, shopping assistance system 300 provides an ability to compensate each participant based on their contributions to system 300.

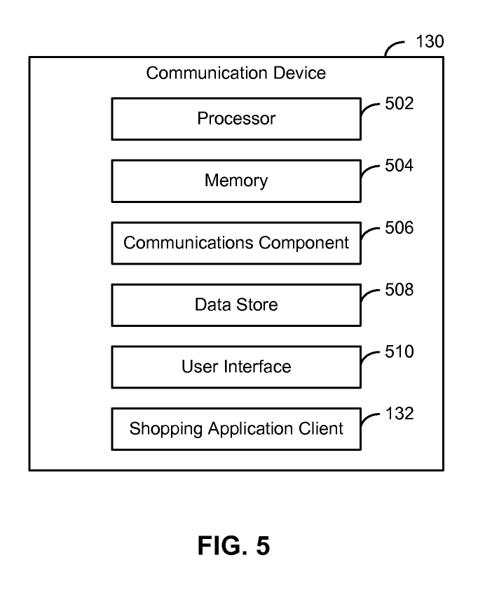

Referring to FIG. 5, in one aspect, communication device 130 (FIG. 1) may include a processor 502 for carrying out processing functions associated with one or more of components and functions described herein. Processor 502 can include a single or multiple set of processors or multi-core processors. Moreover, processor 502 can be implemented as an integrated processing system and/or a distributed processing system.

Communication device 130 further includes a memory 504, such as for storing data used herein and/or local versions of applications being executed by processor 502. Memory 504 can include any type of memory usable by a computer, such as random access memory (RAM), read only memory (ROM), tapes, magnetic discs, optical discs, volatile memory, non-volatile memory, and any combination thereof.

Further, communication device 130 may include a communications component 506 that provides for establishing and maintaining communications with one or more parties utilizing hardware, software, and services as described herein. Communications component 506 may carry communications between components on communication device 130, as well as between communication device 130 and external devices, such as devices located across a communications network and/or devices serially or locally connected to communication device 130. For example, communications component 506 may include one or more buses, and may further include transmit chain components and receive chain components associated with a transmitter and receiver, respectively, operable for interfacing with external devices.

Additionally, communication device 130 may further include a data store 508, which can be any suitable combination of hardware and/or software, that provides for mass storage of information, databases, and programs employed in connection with aspects described herein. For example, data store 508 may be a data repository for applications not currently being executed by processor 502.

Communication device 130 may additionally include a user interface component 510 operable to receive inputs from a user of communication device 130, and further operable to generate outputs for presentation to the user. User interface component 510 may include one or more input devices, including but not limited to a keyboard, a number pad, a mouse, a touch-sensitive display, a navigation key, a function key, a microphone, a voice recognition component, a camera, a bar code reader, a QR code reader, a NFC module, and/or any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

Additionally, in some aspects, communication device 130 may include a shopping assistant client 132, as described above. Shopping assistant client 132 may be configured to implement the shopping functions described above with respect to FIGS. 1-4.

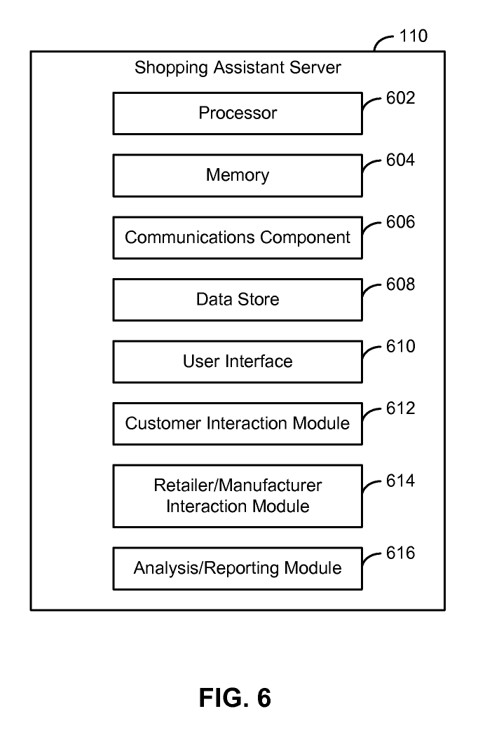

FIG. 6 depicts a shopping assistant server 110 (FIG. 1) in greater detail. Shopping assistant server 110 may include a processor 602, memory 604, communications component 606, data store 608, and user interface 610. These components operate in a manner similar to the corresponding components of communication device 130, and further description will not be provided. In some aspects, shopping assistant server 110 may also include a customer interaction module 612. Customer interaction module 612 may be configured to implement the services provided by customer services layer 420 (FIG. 4), as well as to receive and process customer requests for help, as described herein. Retailer/manufacturer interaction module 614 may be configured to implement the services provided by retailer/manufacturer services layer 440 (FIG. 4). An analysis/reporting module 616 may also be provided for analyzing customer data and generating reports. In one use case, tracked customer interactions may be used to perform “footstream” analysis to follow customer's movements through a store. In an aspect, for example, this information can be helpful in determining ideal product placement.

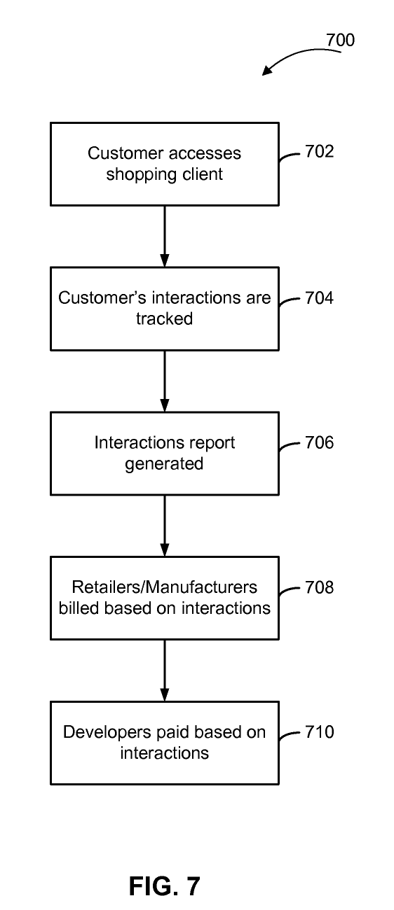

FIG. 7 is a flowchart depicting an aspect of a method 700 of a business model for providing shopping assistance. As depicted at 702, a customer accesses a shopping client. The customer may access the shopping client, for example, by launching a shopping assistant client application on a mobile device. The customer may perform various actions using the application, as described herein. For example, in an aspect, the customer may provide inputs, such as queries or parameters or commands to perform functions, to the shopping assistant client, and receive responses, such as the information or result of the functions described above. As depicted at 704, customer interactions generated from the applications are tracked by the shopping assistant server 110. For example, in an aspect, the customer interactions are communicated from shopping assistant client application to shopping assistant server, which may include a memory for storing the interactions. The shopping assistant server 110 may then generate one or more reports describing the customer's interactions, and these reports may be transmitted to retailers and/or manufacturers. For example, in an aspect, shopping assistant server 110 may include data service in the form of analytics components and/or algorithms that can analyze the stored customer interactions and tally data or determine conclusions based on the interactions, e.g. depending on the specific algorithm or function that is utilized. In an aspect, the retailers and/or manufacturers may then provide payment to the operator of the shopping assistant server 110 for the generated interactions, as depicted at 708. For example, in an aspect, certain customer interactions, such as an inquiry about a product, a movement to a location associated with a product, a purchase of a product, etc., may be characterized as payable events, and thus the payments to the operator of shopping assistant server 110 may be according to some function or rule based on the occurrence of such payable events. Further, in an aspect, the shopping assistant server 110 may then pay the developers of the one or more applications used by the customer to access the shopping assistant server 110, as depicted at 710. For example, in an aspect, the above-noted payable events may correspond to a customer interaction with shopping assistant client 132 developed by application developer 340, and thus a developer payment may be determined according to some function or rule based on the occurrence of such payable events that correspond to the application created by application developer 340.

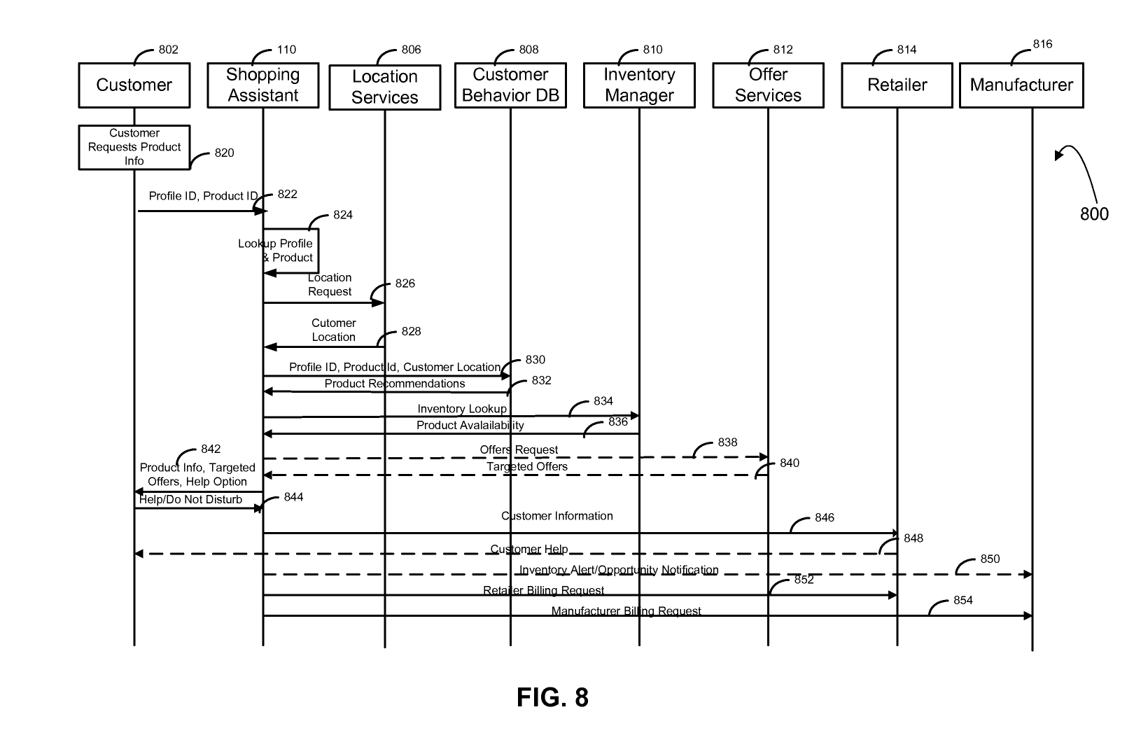

The systems and methods described herein may be applied in various use cases. FIG. 8 depicts one exemplary use case, although it should be understood that a multitude of other use cases are also possible. In FIG. 8, a shopping assistance information exchange 800 includes the transfer of information among a customer 802, a shopping assistant server 110, location services 806, a customer behavior database 808, an inventory manager 810, an offer service 812, a retailer 814, and a manufacturer 816 in order to provide one or more of product information, product recommendations, product offers, or assistance to the customer. As depicted at 820, in one aspect, a customer may request information about a particular product. For example, the customer may scan a QR code or barcode associated with a product while in a retail store. Upon scanning the QR code or barcode, a profile identifier (ID) associated with the customer as well as an identifier associated with the requested product is transmitted to the shopping assistant server 110, as depicted at 822. The profile ID may be, for example, a number or code that uniquely identifies the customer and/or a customer profile associated with the customer and stored at a network server, such as at shopping assistant server 110. The identifier associated with the product may be, for example the QR code or barcode. The shopping assistant server 110 then looks up the customer's profile and the product based on the transmitted identifiers, as depicted at 824.

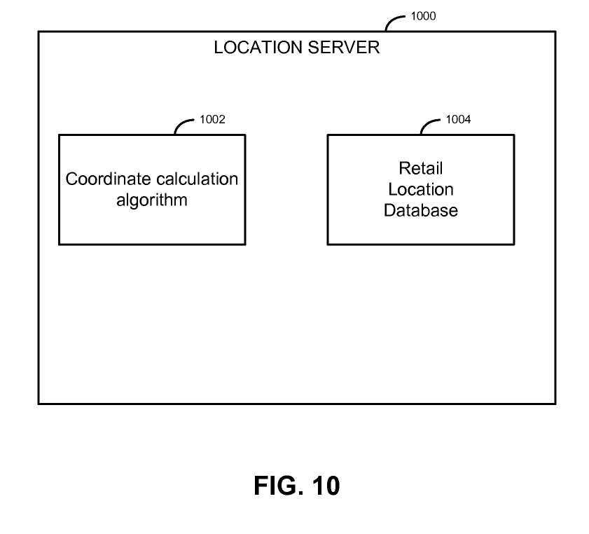

In accordance with some aspects, the shopping assistant server 110 interfaces with a plurality of components to enhance a customer shopping experience. Knowing the location of the customer can also be helpful in providing a positive customer service experience. In one aspect, as depicted at 826, a location request may be transmitted to a location service 806 to determine the customer location. The location service 806 may compute the customer location based on a variety of factors such as, for example, planograms/store maps, in-store wireless access points, GPS or other satellite or terrestrial location information obtained from the mobile device of the customer, or a combination thereof, etc. For example, a customer location may be known, such as via GPS, up to the point of entering a building, while an inside location determination system, e.g. a network of local access points that can trilaterate or triangulate the location of the customer inside the building, and thus the combination of outside and inside location information can be used to accurately locate the customer within the building. In some aspects, the customer's location is determined based on the known locations of one or more products the customer scans. The location service 806 then returns the customer location, as depicted at 828. In one aspect, location service 806 may be implemented by a location server 1000, as depicted in FIG. 10. Location server 1000 may include a retail location database 1004 for storing planograms/store maps/store layout information provided by retailers. Location server 1000 may also include a coordinate calculation algorithm 1002 that calculates latitude/longitudinal coordinates of customers and/or products, for example, as described above by combining both GPS and in-store location information.

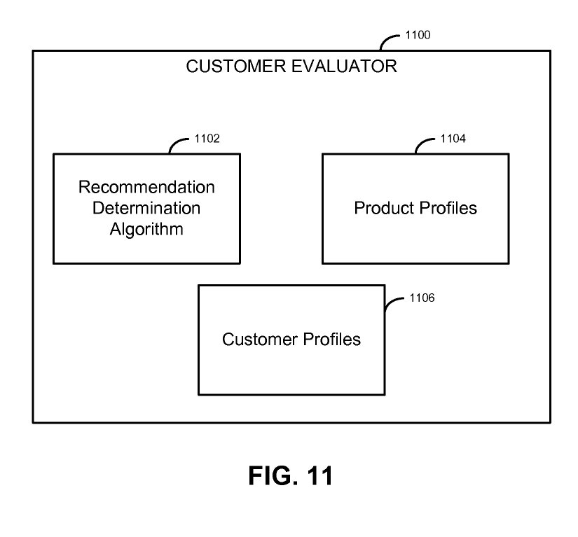

As depicted at 830, the shopping assistant server 110 may transmit the customer profile identifier, the product identifier, and the customer location to a customer behavior database 808. The customer behavior database 808 may be configured to compile information regarding past shopping experiences, habits, and preferences of the customer, and to use this compiled information to make shopping recommendations. As depicted at 832, the customer behavior database may transmit its stored profile associated with the customer as well as recommended products to the shopping assistant server 110. The profile stored by customer behavior database 807 may include information such as size preferences, brand affinities, shopping frequency, an indicator of a priority level (e.g., a measure of how valuable the customer may be to the retailer, for example, based on one or more of a credit rating, purchase history, etc.) associated with the customer, and/or any other tracked customer information. The product recommendations may be based on the requested product and the customer profile information. In one aspect, for example, customer behavior database 808 may be a part of a customer evaluator 1100, shown in FIG. 11, which includes product profiles 1104, e.g. including parameters that define or characterize the respective product, customer profiles 1106, e.g. including parameters that define the customer, the customer buying habits or priority (e.g. buying power), etc., and a recommendation determination algorithm 1102 for determining products to be recommended to a customer based on a correlation of one or more parameters of customer profile 1106 with one or more parameters of one or more product profiles 1104.

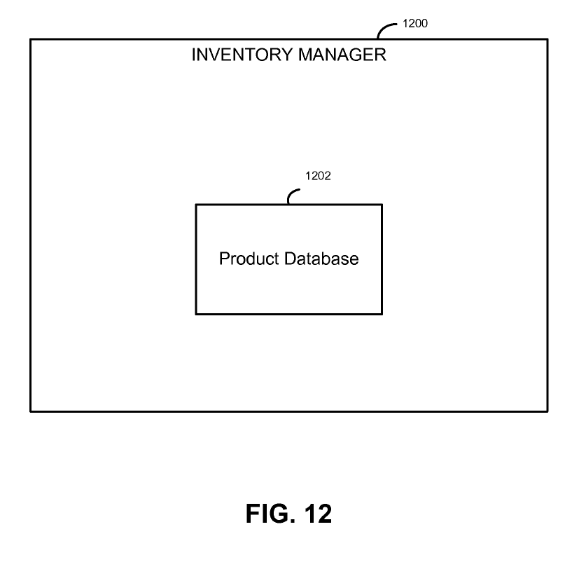

Shopping assistant server 110 may perform an inventory lookup, as depicted at 834, to determine whether the requested product is available. According to some aspects, the shopping assistant server 110 may transmit the product identifier associated with the requested item as well as the customer size and/or other product specific selections to inventory manager 810. The size/other product specific selections may be provided by the customer, or may be obtained from the shopper profile information provided by customer behavior database 808. As depicted at 836, the inventory manager 810 returns product availability information. For example, the availability information may indicate that the requested product is available in store, or if not available in store, may provide alternative locations where the product is available. In an aspect, for example, inventory manager 810 may be implemented by inventory manager 1200, depicted in FIG. 12, which includes a product database 1202 having data such as product identifiers, corresponding stock levels, purchase orders, manufacturing/production volume schedule, etc., thereby indicating what products are or will be available to be supplied to retailers.

In some implementations, the shopping assistant server 110 may request offers to be provided to the customer 802, as depicted at 838, from an offer service 812. Offers may provide incentives, such as discounts, to entice a customer to make a purchase. In some aspects, the offer may be based on any of the customer profile, customer shopping history, customer search history, customer movements through the store, etc. Offer service 812 may then return one or more targeted offers, as depicted at 842. According to some aspects, offer service 812 may determine offers by based on rules provided by the retailer or manufacturer, and/or based on information obtained from customer behavior database 808, location services 806, or inventory manager 810. In an aspect, offers may be based on an amount of time a customer has spent browsing a particular product category. For example, a customer may stand in front of coat display for 10 minutes (as detected by navigation services), and during that time retailer may offers a get $5 off on your next visit offer. The customer may view the offer, but continues browsing. After a period of time, such as 15 minutes have passed, the customer may scan one of the manufacturer's products, and the manufacturer may provide a $20 dollar off if you buy today offer.

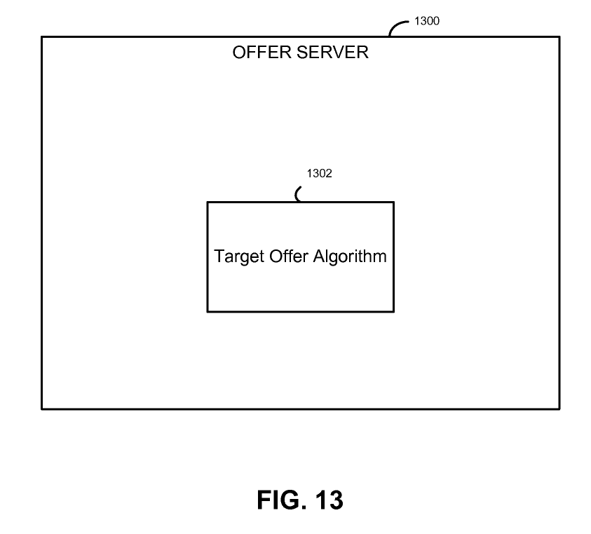

In an aspect, for example, offer service 812 may be implemented by offer server 1300, shown in FIG. 13, which includes a target offer algorithm 1302 for generating targeted offers. For example, target offer algorithm 1302 may receive as inputs customer profile information, including products of interest, etc., manufacturer and/or retailer product or sales offer identification information, and target offer algorithm 1302 may determine a correlation therebetween in order to generate one or more offers potentially of interest to the customer.

Using the information obtained from locations services 806, the customer behavior database 808, the inventory manager 810, and the offer service 812, the shopping assistant server 110 may provide product availability information for the requested product as well as additional product recommendations and targeted offers (if any) to customer 802, as depicted at 842. The shopping assistant server 110 may also query the customer as to whether or not the customer needs additional help, for example, from a retail associate. As depicted at 844, the customer responds indicating whether or not help is desired.

As depicted at 846, customer information is transmitted to retailer 814. According to some aspects, the customer information is transmitted to a tablet or other portable device of a retail associate in or accessible to the customer location. In other aspects, the customer information may be sent to a centralized customer service center. In an aspect, the customer information may include, for example, the customer name, priority status, a photograph of the customer, information about the product(s) the customer is interested in, the customer position or location information, an indication of whether or not the customer wants help, and/or other customer information that may be helpful in providing shopping assistance. As such, the receiving of the customer information enables the retail staff to further interact with the customer and/or track the customer shopping experience. As depicted at 875, if the customer has requested help, a retail associate may be dispatched to help the customer, or alternatively the retailer may call the customer if in-person assistance is not available.

In some implementations, shopping assistant server 110 may provide inventory alerts and/or inventory opportunity notifications directly to manufacturer 816, as depicted at 850. The inventory alerts/opportunity notifications may be based, for example, on the request made by customers for particular products. An inventory alert may be used to inform a manufacturer that a normally stocked product is out-of-stock, while inventory opportunity notifications may be used to notify the manufacturer of that requests have been made for a product that is not normally stocked at the store. The manufacturer may use these alerts to adjust production and/or inventory practices to correlate with customer interests or demands. Once the customer shopping experience is complete, a billing request may be generated by shopping assistant server 110 and transmitted to retailer 814 and/or manufacturer 816, for example, to provide a payment for one or more of the customer interactions through use of the shopping assistant, as depicted at 852, 854.

While not depicted in FIG. 8, in some aspects, a manufacturer may information and/or media, such as videos and images, describing manufactured products. A customer may scan a code associated with the product while in store and be presented with the information and/or media. The manufacturer may then receive information describing the customer interaction, and may use this information to adjust a marketing distribution plan. In some implementations, the customer interaction information may be viewed in an abstracted form. In other implementations, the customer interaction information may be viewed in conjunction with the customer's personal information.

Thus, as described above, in one aspect, shopping assistance information exchange 800 may represent a method and/or apparatus for receiving a request for product information, obtaining a profile associated with the requestor and the product information, obtaining recommendations for one or more additional products based on previous behaviors of the requestor and the requested product, determining availability of the requested product; and providing the availability information and the recommendations for the one or more additional products to the requestor. The method or apparatus may request one or more targeted offers to be presented to the requestor and provide at least one targeted offer to the requestor, wherein the targeted offers are requested from a product manufacturer or a retailer. Requesting one or more offers may comprise reviewing a search history associated with the requestor, and providing at least one offer based on the search history. The method and/or apparatus may determine a location of the requestor and provide a targeted offer to the requestor based on the location of the requestor.

In another aspect, the shopping assistance information exchange 800 may represent a method and/or apparatus for alerting a manufacturer to product demands, comprising receiving a search request for a product, determining if the product is available in a particular store, and alerting the manufacturer if the product is not available. If the product is not available in the particular store, the method and/or apparatus may determine whether the product is normally available in the store, and if the product is not normally available, generate an inventory opportunity alert to the manufacture, alerting the manufacturer that the product should be provided. Generating the inventory opportunity alert may be performed after receiving a number of search requests for a product that exceed a threshold.

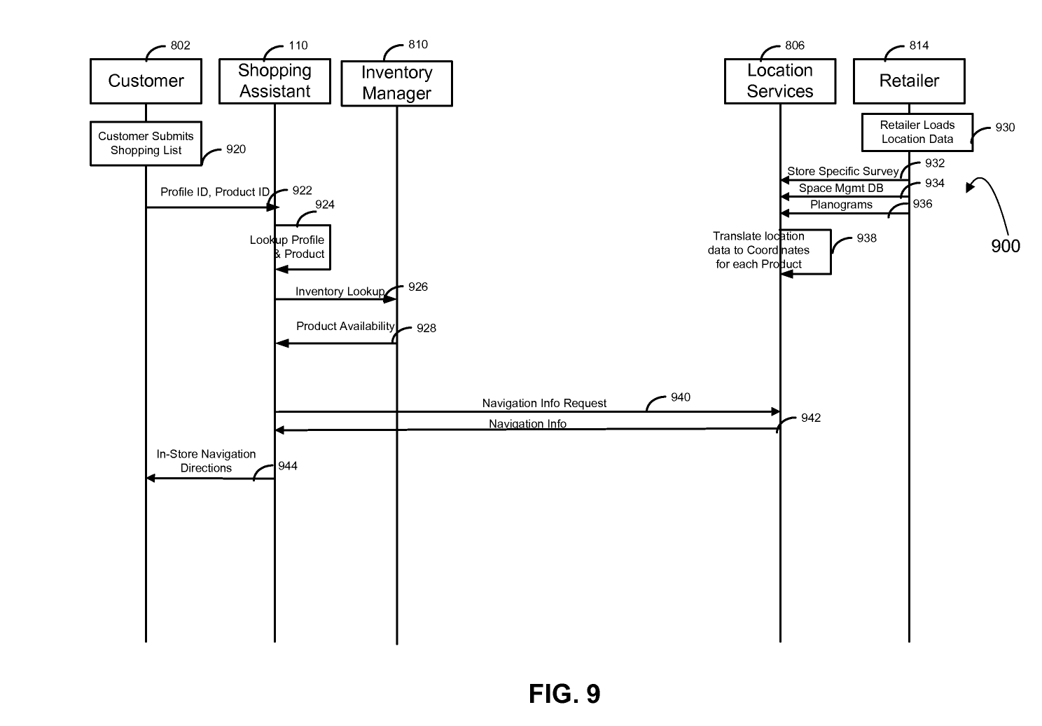

FIG. 9 depicts another exemplary use case. In FIG. 9, a shopping assistance information exchange 900 includes the transfer of information among a customer 802, shopping assistant server 110, inventory manager 810, location services 806, and retailer 814 to provide in-store navigation assistance. As depicted at 920, a customer may submit a shopping list to shopping assistant server 110. The shopping list may be submitted, for example, by entering products into a user interface via the customer mobile device, scanning one or more product QR codes, and or using any other method. As depicted at 922 and 924, in providing the shopping list, the customer provides a profile ID and product identifiers associated with each product on the list, and the shopping assistant server 110 may look up the customer's profile and the products. These steps may be performed in a manner similar to that described above with reference to steps 822 and 824 in FIG. 8.

The shopping assistant server 110 may obtain product availability information by transmitting an inventory lookup request, as depicted at 926, and receiving the results, as depicted at 928. These steps may be performed in a manner similar to that described above with reference to steps 834 and 836 of FIG. 8.

Location services 806 may be configured to obtain information that may be used to provide navigation services to customer 802. As depicted at 930, a retailer may load location data to be transmitted to location services 806. The location data may include, for example, store specific survey information, as depicted at 932, information from retailer headquarters space management database, as depicted at 934, and retailer headquarters planograms, as depicted at 936. The planograms may describe, for example, specific product layout information relevant to all stores of a particular retail chain. Store specific survey information refers to the specifics of an individual store. For example, this information may include engineering diagrams/space plans for the particular store. Using the store specific survey, information from the retailer headquarters space management database, and retailer headquarters planograms, the location services 806 may translate the retailer location data into latitude/longitudinal coordinates for each product in a store, as depicted at 938.

As depicted at 940, the shopping assistant server 110 may transmit a navigation information request to location services 806, requesting location information associated with the products on the customer shopping list. The product location information is then returned to the shopping assistant, as depicted at 942. The shopping assistant server 110 may then provide in-store navigation directions to the customer, as depicted at 944. In some aspects, the navigation directions are calculated by location services 806. In other aspects, the navigation directions may be calculated by shopping assistant server 110.

Thus, as described above, in one aspect, shopping assistance information exchange 900 may represent a method and/or apparatus for providing in-store navigation, comprising receiving a request for one or more products, retrieving a customer profile and an identifier associated with each of the one or more products, and generating in-store navigation directions indicating directions to each of the one or more products. Generating may further comprise receiving a store specific survey describing a geography of the store, the survey including a store location comprising latitude and longitude coordinates associated with a location of the store, receiving retailer planograms outlining product layout information, and generating a product location comprising latitude and longitude coordinates for each product in the store based on the store specific survey and the retailer planograms. The method and/or apparatus may also determine availability of each of the one or more products, and generate in-store navigation directions only for those products that are available in-store. The method and/or apparatus may determine a requestor location for the requestor of the one or more products, and calculate the in-store navigation directions from the determined requestor location to the respective product location of each of the one or more products. The requestor location may be determined based on a combination of location coordinates provided by a mobile device used by the requestor, the store specific survey, and the retailer planograms.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for providing onsite customer assistance, comprising:
receiving a help-related message from a customer; and
determining whether to dispatch help to the customer based on the help-related message and a customer profile corresponding to the customer.

2. The method of claim 1, wherein the help-related message comprises a request for help, and wherein determining whether to dispatch help further comprises determining to send an assistant to the customer.

3. The method of claim 2, wherein the customer profile includes customer profile data including one or more of a priority level associated with the customer, a credit rating, a purchase history, a loyalty account, an income level, a known need of the customer, or an interest of the customer, and wherein determining to send the assistant is further based on one or more of the customer profile data.

4. The method of claim 3, wherein determining to send the assistant based on one or more of the customer profile data further comprises determining one or more of a priority of sending help to the customer versus sending help to other customers, a type of expertise of the assistant, a location of the assistant to instruct to provide the help, an identity of the assistant, or an employment level or title of the assistant.

5. The method of claim 1, wherein the help-related message comprises a do not disturb request, and wherein determining whether to dispatch help further comprises determining to not send an assistant to help the customer.

6. The method of claim 5, further comprising sending a do not disturb message to one or more assistants including an identification of the customer and an instruction to not ask the customer if help is needed.

7. The method of claim 2, further comprising:
receiving a request for information about one or more products from the customer;
determining a location of the one or more products;
determining a location for the customer based on the location of the one or more products; and
dispatching the assistant to help the customer based on the customer profile and the location of the customer.

8. The method of claim 7, wherein receiving the request for information about the one or more products comprises receiving an indication that a barcode or QR code associated with the one or more products has been scanned.

9. The method of claim 7, wherein determining a location of the one or more products comprises:
receiving a store specific survey describing a geography of a store, the store specific survey including a store location comprising latitude and longitude coordinates associated with a location of the store;
receiving one or more retailer planograms outlining product layout information; and
generating a product location comprising latitude and longitude coordinates for each product in the store based on the store specific survey and the retailer planograms.

10. The method of claim 9, wherein the location of the customer is determined based on a combination of location coordinates provided by a mobile device used by the customer, the store specific survey, and the one or more retailer planograms.

11. The method of claim 7, further comprising:
obtaining one or more recommendations for one or more additional products based on the request for information, and on previous behaviors of the customer;
determining availability of the one or more products associated with the request for information; and
providing an availability indicator and the one or more recommendations for the one or more additional products to the customer.

12. The method of claim 7, further comprising:
requesting one or more targeted offers to be presented to the customer; and
providing at least one targeted offer to the customer.

13. The method of claim 12, wherein requesting one or more targeted offers comprises:
reviewing a search history associated with the customer; and
providing at least one offer based on the search history.

14. The method of claim 12, wherein the at least one targeted offer is based on the location of the customer.

15. The method of claim 7, further comprising:
determining availability of each of the one or more products; and
generating in-store navigation directions from the determined customer location to the respective product location for those products available in-store.

16. The method of claim 15, wherein the in-store navigation directions are dynamically generated based on the customer profile and the determined customer location to route the customer along a desired path.

17. The method of claim 7, further comprising:
determining if the one or more products are available in a particular store; and
alerting a manufacturer of the one or more products if a product is not available.

18. The method of claim 17, wherein if a product is not available in the particular store, the method further comprises:
determining whether the product is normally available in the store; and
if the product is not normally available, generating an inventory opportunity alert to the manufacture, alerting the manufacturer that the product should be provided.

19. The method of claim 7, further comprising:
transmitting an anonymous version of the customer profile to a plurality of manufacturers of at least one of the one or more products;
receiving bids from the plurality of manufacturers representing a discount to be applied to the at least one product; and
generating a coupon representing a highest bid.

20. The method of claim 7, further comprising:
monitoring movements of the customer through the location;
storing customer movement information for a plurality of customers; and
determining product placement based on the stored customer movement information.

21. The method of claim 7, further comprising:
collecting behavior information for a plurality of customers; and
transmitting anonymous customer behavior information to a manufacturer for a fee.

22. The method of claim 7, further comprising:
detecting that the customer has entered a location based on a geo-fence located around the location;
automatically launching a mobile application on a mobile device associated with the customer upon determining that the customer has entered the location.

23. The method of claim 7, further comprising determining a route to another location of another product based on the customer profile.

24. A computer program product, comprising:
a computer-readable medium, comprising:
a first set of instructions for causing a computer to receive a help-related message from a customer; and
a second set of instructions for causing the computer to determine whether to dispatch help to the customer based on the help-related message and a customer profile corresponding to the customer.

25. An apparatus comprising:
means for receiving a help-related message from a customer; and
means for determining whether to dispatch help to the customer based on the help-related message and a customer profile corresponding to the customer.

26. An apparatus for providing shopping assistance, comprising:
at least one processor configured to receive a help-related message from a customer and to determine whether to dispatch help to the customer based on the help-related message and a customer profile corresponding to the customer; and
a memory coupled to the at least one processor.

27. The apparatus of claim 26, wherein the help-related message comprises a request for help, and wherein the at least one processor is further configured to determine whether to dispatch help further comprises determining to send an assistant to the customer.

28. The apparatus of claim 27, wherein the customer profile includes customer profile data including one or more of a priority level associated with the customer, a credit rating, a purchase history, a loyalty account, an income level, a known need of the customer, or an interest of the customer, and wherein determining to send the assistant is further based on one or more of the customer profile data.

29. The apparatus of claim 27, wherein the at least one processor is further configured to determine one or more of a priority of sending help to the customer versus sending help to other customers, a type of expertise of the assistant, a location of the assistant to instruct to provide the help, an identity of the assistant, or an employment level or title of the assistant.

30. The apparatus of claim 26, wherein the help-related message comprises a do not disturb request, and wherein the at least one processor is further configured to determine to not send an assistant to help the customer.

31. The apparatus of claim 30, wherein the at least one processor is further configured to send a do not disturb message to one or more assistants including an identification of the customer and an instruction to not ask the customer if help is needed.

32. The apparatus of claim 27, wherein the at least one processor is further configured to:
receive a request for information about one or more products from the customer;
determine a location of the one or more products;
determine a location for the customer based on the location of the one or more products; and
dispatch the assistant to help the customer based on the customer profile and the location of the customer.

33. The apparatus of claim 32, wherein the at least one processor is further configured to receive an indication that a barcode or QR code associated with the one or more products has been scanned.

34. The apparatus of claim 32, wherein the at least one processor is further configured to determine a location of the one or more products by:
receiving a store specific survey describing a geography of a store, the store specific survey including a store location comprising latitude and longitude coordinates associated with a location of the store;
receiving one or more retailer planograms outlining product layout information; and
generating a product location comprising latitude and longitude coordinates for each product in the store based on the store specific survey and the retailer planograms.

35. The apparatus of claim 34, wherein the location of the customer is determined based on a combination of location coordinates provided by a mobile device used by the customer, the store specific survey, and the one or more retailer planograms.

36. The apparatus of claim 32, wherein the at least one processor is further configured to:
obtain one or more recommendations for one or more additional products based on the request for information, and on previous behaviors of the customer;
determine availability of the one or more products associated with the request for information; and
provide an availability indicator and the one or more recommendations for the one or more additional products to the customer.

37. The apparatus of claim 32, wherein the at least one processor is further configured to:
request one or more targeted offers to be presented to the customer; and
provide at least one targeted offer to the customer.

38. The apparatus of claim 37, wherein the at least one processor is configured to request one or more targeted offers by:
reviewing a search history associated with the customer; and
providing at least one offer based on the search history.

39. The apparatus of claim 37, wherein the at least one targeted offer is based on the location of the customer.

40. The apparatus of claim 32, wherein the at least one processor is further configured to:
determine availability of each of the one or more products; and
generate in-store navigation directions from the determined customer location to the respective product location for those products available in-store.

41. The apparatus of claim 40, wherein the in-store navigation directions are dynamically generated based on the customer profile and the determined customer location to route the customer along a desired path.

42. The apparatus of claim 32, wherein the at least one processor is further configured to:
determine if the one or more products are available in a particular store; and
alert a manufacturer of the one or more products if a product is not available.

43. The apparatus of claim 42, wherein if the product is not available in the particular store, the at least one processor is further configured to:
determine whether the product is normally available in the store; and
if the product is not normally available, generate an inventory opportunity alert to the manufacture, alerting the manufacturer that the product should be provided.

44. The apparatus of claim 32, wherein the at least one processor is further configured to:
transmit an anonymous version of the customer profile to a plurality of manufacturers of at least one of the one or more products;
receive bids from the plurality of manufacturers representing a discount to be applied to the at least one product; and
generate a coupon representing a highest bid.

45. The apparatus of claim 32, wherein the at least one processor is further configured to:
monitor movements of the customer through the location;
store customer movement information for a plurality of customers; and
determine product placement based on the stored customer movement information.

46. The apparatus of claim 32, wherein the at least one processor is further configured to:
collect behavior information for a plurality of customers; and
transmit anonymous customer behavior information to a manufacturer for a fee.

47. The apparatus of claim 32, wherein the at least one processor is further configured to:
detect that the customer has entered a location based on a geo-fence located around the location;
automatically launch a mobile application on a mobile device associated with the customer upon determining that the customer has entered the location.

48. The apparatus of claim 32, wherein the at least one processor is further configured to determine a route to another location of another product based on the customer profile.
